(19) United States
(12) Patent Application Publication
(10) Pub. No.: US 2026/0154842 A1
(43) Pub. Date: Jun. 4, 2026

(54) FURNITURE DETECTION APPARATUS, FURNITURE DETECTION METHOD, AND RECORDING MEDIUM

(71) Applicant: NEC Corporation, Tokyo (JP)

(72) Inventor: Shusuke MATSUDA, Tokyo (JP)

(73) Assignee: NEC Corporation, Tokyo (JP)

(21) Appl. No.: 19/368,166

(22) Filed: Oct. 24, 2025

(30) Foreign Application Priority Data
Dec. 3, 2024 (JP) 2024-210153

(51) Int. Cl. G06T 7/70; G06T 7/13

(52) U.S. Cl. CPC G06T 7/70; G06T 7/13; G06T 2207/30242

(57) ABSTRACT

A furniture detection apparatus includes: one or more memories storing instructions; and one or more processors configured to execute the instructions to: specify , based on position information regarding a plurality of shelf boards in an image captured in such a way that a plurality of pieces of furniture is included, transition of a number of shelf boards in a lateral direction of the plurality of pieces of furniture included in the image; detect a position in the lateral direction, the position having a minimal value in the transition of the number of shelf boards in the lateral direction; and detect the pieces of furniture from the image, based on the position in the lateral direction detected.

This application is based upon and claims the benefit of priority from Japanese Patent Application No. 2024-210153, filed on December 3, 2024, the disclosure of which is incorporated herein in its entirety by reference.

### TECHNICAL FIELD

The present disclosure relates to a furniture detection apparatus and the like.

### BACKGROUND ART

In retail and manufacturing industries, products displayed on shelf furniture such as store fixture and storage rack may be recognized. Hereinafter, shelf furniture may be simply referred to as furniture. For example, JP 2023-115988 A describes that information indicating a display status of furniture on which pieces of merchandise are displayed is acquired from a terminal used by a customer, and an insufficient piece of merchandise is specified based on the information indicating the display status.

### SUMMARY

In a case where a plurality of pieces of furniture is arranged, in order to accurately detect products displayed on each piece of furniture, it is desired to accurately detect the piece of furniture from an image in which the plurality of pieces of furniture is captured.

An object of the present disclosure is to provide a furniture detection apparatus and the like capable of accurately detecting, from an image in which a plurality of pieces of furniture is captured, each of the plurality of pieces of furniture.

A furniture detection apparatus according to one aspect of the present disclosure includes a number-of-shelf-boards specifying unit for specifying, based on position information regarding a plurality of shelf boards in an image captured in such a way that a plurality of pieces of furniture is included, transition of the number of shelf boards in a lateral direction of the plurality of pieces of furniture included in the image, a peak detection unit for detecting a position in the lateral direction, the position having a minimal value in the transition of the number of shelf boards in the lateral direction, and a furniture detection unit for detecting the pieces of furniture from the image, based on the position in the lateral direction detected.

In a furniture detection method according to one aspect of the present disclosure, at least one computer executes processing of specifying, based on position information regarding a plurality of shelf boards in an image captured in such a way that a plurality of pieces of furniture is included, transition of the number of shelf boards in a lateral direction of the plurality of pieces of furniture included in the image, detecting a position in the lateral direction, the position having a minimal value in the transition of the number of shelf boards in the lateral direction, and detecting the pieces of furniture from the image, based on the position in the lateral direction detected.

A program according to one aspect of the present disclosure causes at least one computer to execute processing of specifying, based on position information regarding a plurality of shelf boards in an image captured in such a way that a plurality of pieces of furniture is included, transition of the number of shelf boards in a lateral direction of the plurality of pieces of furniture included in the image, detecting a position in the lateral direction, the position having a minimal value in the transition of the number of shelf boards in the lateral direction, and detecting the pieces of furniture from the image, based on the position in the lateral direction detected.

Each of programs may be stored in a non-transitory recording medium readable by the at least one computer.

According to the present disclosure, it is possible to accurately detect, from an image in which a plurality of pieces of furniture is captured, each piece of furniture.

### BRIEF DESCRIPTION OF THE DRAWINGS

FIG. 1 is a block diagram illustrating a configuration example of a furniture detection apparatus;

FIG. 2 is an explanatory diagram illustrating an image in which pieces of furniture are captured;

FIG. 3 is an explanatory diagram illustrating position information regarding shelf boards;

FIG. 4 is an explanatory diagram illustrating a correspondence relationship between a graph indicating transition of the number of the shelf boards and end points of the shelf boards;

FIG. 5 is an explanatory diagram illustrating an example in which pieces of furniture are detected;

FIG. 6 is a flowchart illustrating an operation example of the furniture detection apparatus;

FIG. 7 is a block diagram illustrating a configuration example of a furniture detection apparatus;

FIG. 8 is an explanatory diagram illustrating a selection example of a combination of shelf labels closest to each other, in a height direction, and a straight line example;

FIG. 9 is a flowchart illustrating an operation example of the furniture detection apparatus; and

FIG. 10 is an explanatory diagram illustrating a hardware configuration example of a computer.

### EXAMPLE EMBODIMENT

Hereinafter, with reference to the drawings, description will be given of example embodiments of a furniture detection apparatus, a furniture detection method, a program, and a non-transitory recording medium for recording the program according to the present disclosure. The present example embodiments do not limit the disclosed technique.

### First Example Embodiment

In a first example embodiment, basic functions of a furniture detection apparatus will be described in detail with reference to the drawings.

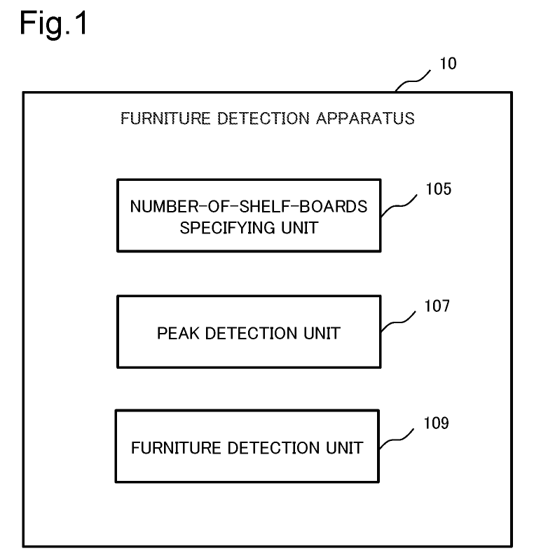

FIG. 1 is a block diagram illustrating a configuration example of a furniture detection apparatus 10. The furniture detection apparatus 10 includes a number-of-shelf-boards specifying unit 105, a peak detection unit 107, and a furniture detection unit 109.

Here, furniture is installed in retail industries, manufacturing industries, warehouse industries, and the like. For example, products are displayed on the furniture. The products may be referred to as pieces of merchandise. For example, there is a case where an imaging device captures an image of a plurality of pieces of furniture, and from the image captured, products, the number of faces and displays of the products, and the like are detected and used for inventory management and the like. On each piece of furniture, in general, products are displayed in a depth direction, that is, a vertical direction with respect to the piece of furniture. In order to capture an image of a face surface of a product, it is desirable to capture the image in the vertical direction with respect to the piece of furniture as much as possible. However, there is a case where the imaging device cannot capture an image in the depth direction of a shelf, that is, in the vertical direction of the shelf. For this reason, in order to specify a region of products displayed on each piece of furniture, it is desirable to detect the piece of furniture with higher accuracy first. Thus, based on position information regarding a plurality of shelf boards in an image captured so that the plurality of pieces of furniture is included, the furniture detection apparatus 10 detects each piece of furniture from the plurality of pieces of furniture included in the image. The image may be, for example, an RGB (Red, Green, Blue) image.

The number-of-shelf-boards specifying unit 105 specifies, based on the position information regarding the plurality of shelf boards in the image captured so that the plurality of pieces of furniture is included, transition of the number of shelf boards in a lateral direction of the plurality of pieces of furniture included in the image. The plurality of pieces of furniture may be in a state where products are displayed in a store, for example. The imaging device may be, for example, a device provided in a mobile body or a fixedly arranged device. The mobile body may be, for example, a robot that can move autonomously or equipment that can move on a rail, and is not particularly limited. The rail may be installed on a floor or may be installed on pieces of furniture facing each other.

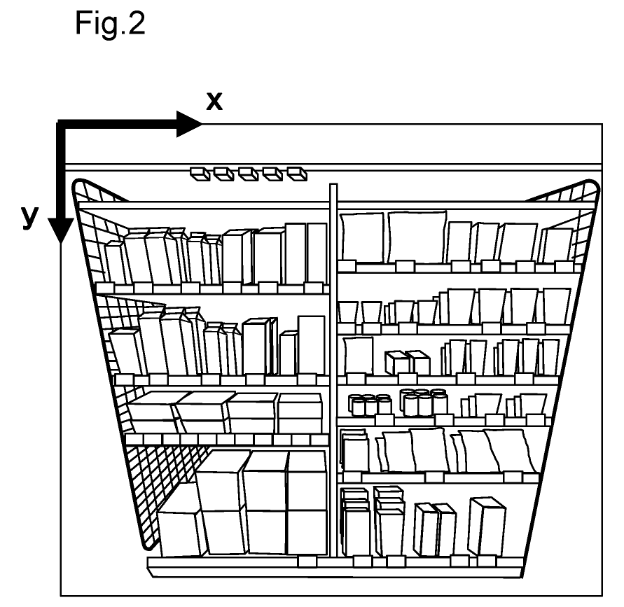

FIG. 2 is an explanatory diagram illustrating an image in which pieces of furniture are captured. In FIG. 2, there are two pieces of furniture, and a shelf label is attached to each shelf board. Since the image cannot be captured from the vertical direction, the image is not exactly a front view image of the pieces of furniture. Here, in the image, the lateral direction of the shelf is an x-axis direction, and a height direction of the shelf is a y-axis direction. Here, the direction toward the right side of the shelf in the x-axis direction, and the direction toward the lower side of the shelf in the y-axis direction, are positive directions.

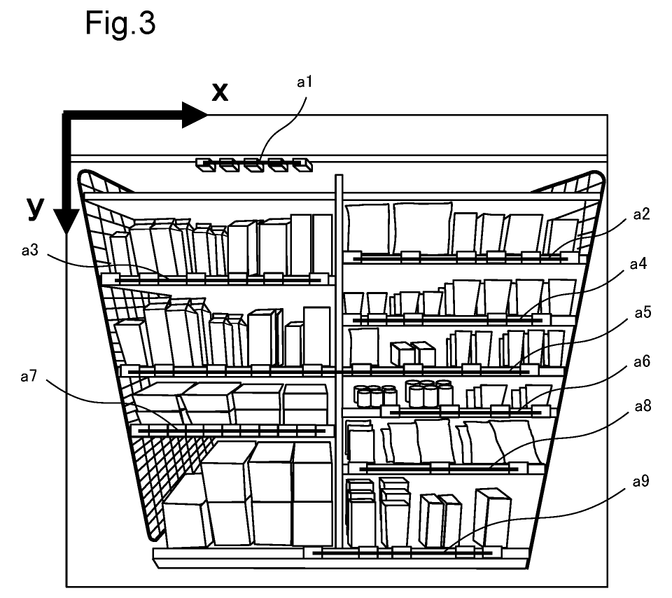

FIG. 3 is an explanatory diagram illustrating position information regarding the shelf boards. The position information regarding the shelf boards is not particularly limited. For example, the position information regarding the shelf boards may be acquired from a storage unit or the like, or may be estimated from shelf labels installed on the shelf boards. In FIG. 3, there are shelf boards a1 to a9. For example, the position information regarding the shelf boards is represented by coordinate values using the x-axis and the y-axis. An example in which the position information regarding the shelf boards is estimated from the shelf labels installed on the shelf boards will be described in a second example embodiment.

The number-of-shelf-boards specifying unit 105 specifies, as a shelf board region, a range from an upper limit value in the lateral direction to a lower limit value in the lateral direction of each of the plurality of shelf boards. However, here, the number-of-shelf-boards specifying unit 105 specifies, as the shelf board region, a range of a value equal to or less than the upper limit value in the lateral direction and larger than the lower limit value in the lateral direction of each of the plurality of shelf boards. Specifically, the following relationship holds for the shelf board region.

### lower limit value < shelf board region ≤ upper limit value

The number-of-shelf-boards specifying unit 105 specifies the transition of the number of shelf boards, based on the shelf board region of each of the plurality of shelf boards. However, in FIG. 3, installed equipment or the like in a facility is erroneously detected as a shelf label or the like, whereby a shelf board may be erroneously detected. In FIG. 3, since installed equipment attached to the ceiling is erroneously detected as a shelf label, the shelf board a1 is erroneously detected.

In a case where there are shelf boards at the same height in the plurality of pieces of furniture, it may be detected as one shelf board. For example, in FIG. 3, the shelf board a5 is erroneously detected as a long shelf board in a portion where shelf boards of two pieces of furniture are at the same height. The number-of-shelf-boards specifying unit 105 may exclude, from counting of the number of shelf boards, a shelf board having an inappropriate size such as a shelf board that is too long or too short in the lateral direction (x-axis direction). Specifically, for example, the number-of-shelf-boards specifying unit 105 may exclude, from the counting of the number of shelf boards, a shelf board in a case where the size of the shelf board region in the lateral direction is out of a predetermined range. The predetermined range only needs to be set to a range that is not too short and not too long. The predetermined range may be set based on, for example, sizes of the pieces of furniture introduced to the store. For example, in FIG. 3, since the shelf board a1 is too short and the shelf board a5 is too long, the shelf board a1 and the shelf board a5 are excluded from the counting of the number of shelf boards.

In a case where the number-of-shelf-boards specifying unit 105 specifies the number of shelf boards at all coordinate values in the lateral direction (x-axis direction), it is expected that specifying processing takes time. The number-of-shelf-boards specifying unit 105 may therefore specify the transition of the number of shelf boards by setting points that are the upper limit value and the lower limit value of each of the plurality of shelf boards on the x-axis as end points and specifying the number of shelf boards at each of the end points.

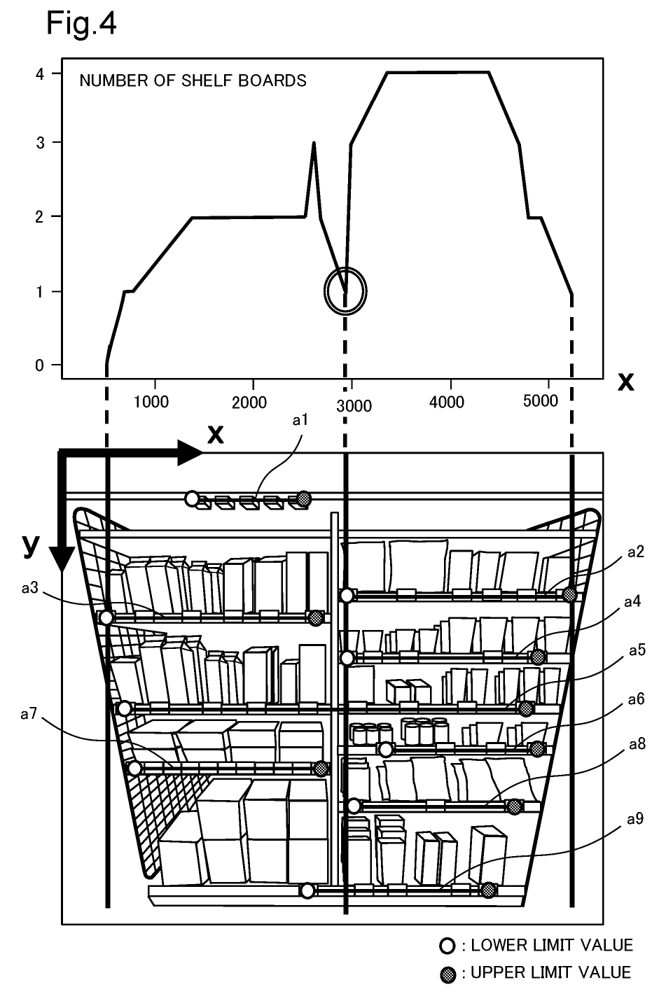

FIG. 4 is an explanatory diagram illustrating a correspondence relationship between a graph indicating transition of the number of the shelf boards and end points of the shelf boards. In the graph, the vertical axis represents the number of shelf boards, and the horizontal axis is the x-axis that represents the lateral direction of the shelf. In the graph, the number of shelf boards at each end point is plotted. In the image, the upper limit value and the lower limit value of each shelf board are displayed for easy understanding.

As described above, since the relationship of lower limit value < shelf board region ≤ upper limit value is satisfied, the counting is not performed for a shelf board having an end point that is the lower limit value of the shelf board. As described above, the counting is not performed for the shelf board a5 and the shelf board a1. The number of shelf boards at the lower limit value of the shelf board a3 is therefore zero. The number of shelf boards at the lower limit value of the shelf board a5 is one since the counting target is only the shelf board a3. The number of shelf boards at the lower limit value of the shelf board a7 is one since the counting target is only the shelf board a3. The number of shelf boards at the lower limit value of the shelf board a1 is two since the counting targets are the shelf board a3 and the shelf board a7. As described above, the number-of-shelf-boards specifying unit 105 specifies the transition of the number of shelf boards with the upper limit value and the lower limit value of each shelf board as end points, whereby it is possible to shorten a processing time required for the specification.

The peak detection unit 107 detects a position in the lateral direction, the position having a minimal value in the transition of the number of shelf boards in the lateral direction. Here, the peak detection unit 107 only needs to set end points of both ends as ends of the plurality of pieces of furniture, and detect an end point where the number of shelf boards is a minimal value. In FIG. 4, a position for which a circle mark is placed on the graph is a position where the number of shelf boards is one and is the minimal value. An x coordinate value of this position may be referred to as a reference value.

The peak detection unit 107 may detect a position where the number of shelf boards is a peak (maximal value) by multiplying the transition of the number of shelf boards by -1.

The furniture detection unit 109 detects the pieces of furniture from the image, based on the detected position in the lateral direction. In FIG. 4, since the relationship of lower limit value < shelf board region ≤ upper limit value is satisfied, the reference value is the lower limit value of a certain shelf board in the lateral direction (x-axis direction). In particular, in a case where the position information regarding the shelf boards is estimated based on position information regarding the shelf labels, the reference value is an x coordinate value of shelf labels arranged at ends on the shelf board a2 and the shelf board a4, that is, the lower limit value of the x coordinates of the shelf board a2 and the shelf board a4. It is therefore predicted that an end of a piece of furniture, that is, a boundary of the piece of furniture is present in a negative direction in the lateral direction (x-axis direction) from the shelf label. The furniture detection unit 109 therefore specifies a boundary between the plurality of pieces of furniture, based on the detected position in the lateral direction, and detects each piece of furniture from the image, based on the specified boundary. As processing of specifying the boundary more specifically, the furniture detection unit 109 specifies a boundary including a position near the detected position as a boundary between the plurality of pieces of furniture. In more detailed description, the furniture detection unit 109 specifies upper limit values present in a negative direction in the x-axis direction from the reference value in a set of upper limit values in the lateral direction of the shelf boards. The furniture detection unit 109 specifies a maximum value among the specified upper limit values. In a case where a plurality of pieces of furniture is arranged, the maximum value is an x-coordinate value of a shelf label installed at an end of a shelf board of a piece of furniture adjacent to a piece of furniture having the reference value. In FIG. 4, the upper limit value of the shelf board a7 in the x-axis direction is the maximum value. It is estimated that there is the boundary between the plurality of pieces of furniture, between the maximum value and the reference value. Thus, the furniture detection unit 109 specifies a position between the maximum value and the reference value as an x-coordinate value of the boundary between the plurality of pieces of furniture. The position between the maximum value and the reference value may be, for example, a position that is an average value of the maximum value and the reference value.

The furniture detection unit 109 detects regions sandwiched between the specified boundary and the ends of the plurality of pieces of furniture as pieces of furniture.

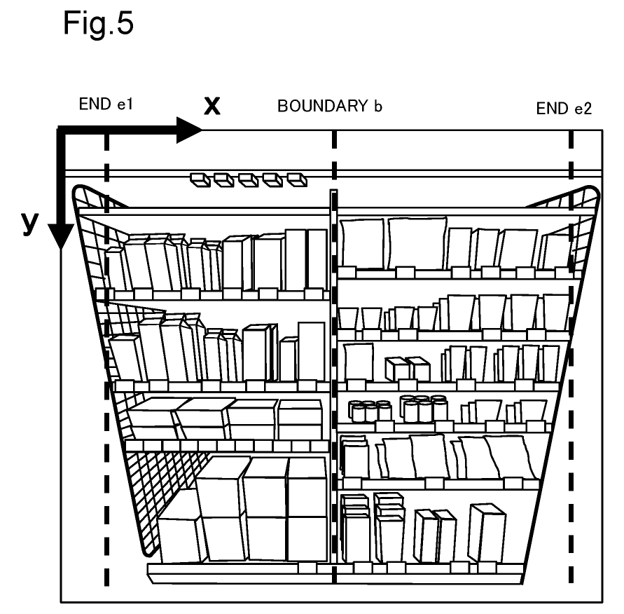

FIG. 5 is an explanatory diagram illustrating an example in which pieces of furniture are detected. In FIG. 5, the furniture detection unit 109 detects a region sandwiched between a boundary b and an end e1 of a piece of furniture and a region sandwiched between the boundary b and an end e2 of a piece of furniture as pieces of furniture. The end e2 of the piece of furniture is a position where x coordinates of the plurality of shelf boards are maximized. The end e1 of the piece of furniture is a position where the x coordinates of the plurality of shelf boards are minimized.

In FIG. 5, an image in which two pieces of furniture are arranged is taken as an example, but it is only required to perform similar processing only needs to be performed even if three or more pieces of furniture are arranged. For example, in the case of a photograph in which three pieces of furniture are arranged, two positions are detected where minimal values are obtained.

### Flowchart

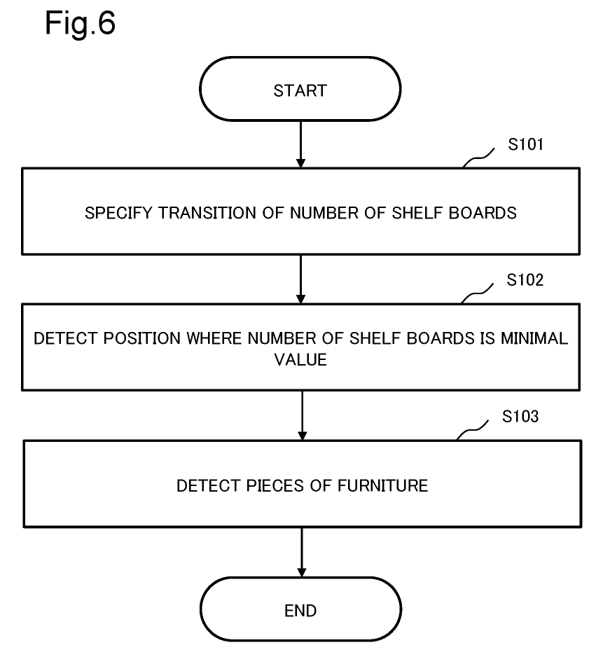

FIG. 6 is a flowchart illustrating an operation example of the furniture detection apparatus 10. The number-of-shelf-boards specifying unit 105 specifies, based on the position information regarding the plurality of shelf boards in the image captured so that the plurality of pieces of furniture is included, transition of the number of shelf boards in the lateral direction of the plurality of pieces of furniture included in the image (step S101). Next, the peak detection unit 107 detects a position in the lateral direction, the position having a minimal value in the transition of the number of shelf boards in the lateral direction (step S102). The furniture detection unit 109 detects the pieces of furniture from the image, based on the detected position in the lateral direction (step S103), and the furniture detection apparatus 10 ends a series of processes illustrated in FIG. 6.

As described above, in the first example embodiment, the furniture detection apparatus 10 specifies, based on position information regarding a plurality of shelf boards in an image captured so that a plurality of pieces of furniture is included, transition of the number of shelf boards in the lateral direction of the plurality of pieces of furniture included in the image, and detects a position in the lateral direction, the position having a minimal value in the transition of the number of shelf boards in the lateral direction. The furniture detection apparatus 10 detects the plurality of pieces of furniture from the image, based on the detected position in the lateral direction. According to the furniture detection apparatus 10, it is possible to accurately detect the plurality of pieces of furniture. As described above, for example, there is a case where the image cannot be captured in the vertical direction with respect to a face surface of the pieces of furniture. The pieces of furniture can be accurately detected even if an angle of view is inclined with respect to the face surface of the pieces of furniture.

For example, in order to capture an image of the pieces of furniture, the image being captured in the vertical direction with respect to a face surface of the pieces of furniture, panoramic images captured by a plurality of imaging devices may be combined to capture an image whose imaging direction is vertical to the face surface of the pieces of furniture. Obtaining an image captured in the vertical direction with respect to the face surface of the pieces of furniture in this way requires a plurality of imaging devices, which is costly. Thus, even in a case where the plurality of imaging devices is not used, according to the furniture detection apparatus 10, it is possible to accurately detect the pieces of furniture.

The furniture detection apparatus 10 specifies a boundary between the plurality of pieces of furniture, based on the detected position in the lateral direction, and detects the plurality of pieces of furniture from the image, based on the specified boundary. In particular, the furniture detection apparatus 10 specifies a boundary including a position near the detected position as the boundary between the plurality of pieces of furniture. In particular, the furniture detection apparatus 10 specifies, as the shelf board region, a range of a value equal to or less than the upper limit value in the lateral direction and larger than the lower limit value in the lateral direction of each of the plurality of shelf boards, and specifies the transition of the number of shelf boards, based on the shelf board region of each of the plurality of shelf boards. As a result, the boundary between the plurality of pieces of furniture can be detected with higher accuracy.

In a case where the size of the shelf board region in the lateral direction is out of the predetermined range, the furniture detection apparatus 10 excludes the shelf board region whose size is out of the predetermined range in the counting of the number of shelf boards. As a result, it is possible to exclude a shelf board erroneously detected when the transition of the number of shelf boards is specified.

The furniture detection apparatus 10 may require a large amount of processing to specify the number of shelf boards at all coordinate values in the lateral direction. Thus, the furniture detection apparatus 10 specifies the number of shelf boards at each of the upper limit value and the lower limit value in the lateral direction of each of the plurality of shelf boards indicated by the position information regarding the plurality of shelf boards, thereby specifying the transition of the number of shelf boards. As a result, the amount of processing can be reduced.

### Second Example Embodiment

A second example embodiment will be described in detail with reference to the drawings. In the second example embodiment, an example will be described in which a shelf board is estimated from shelf labels. Hereinafter, the description of content that is duplicate of the description above will be omitted to the extent that description of the second example embodiment is not unclear.

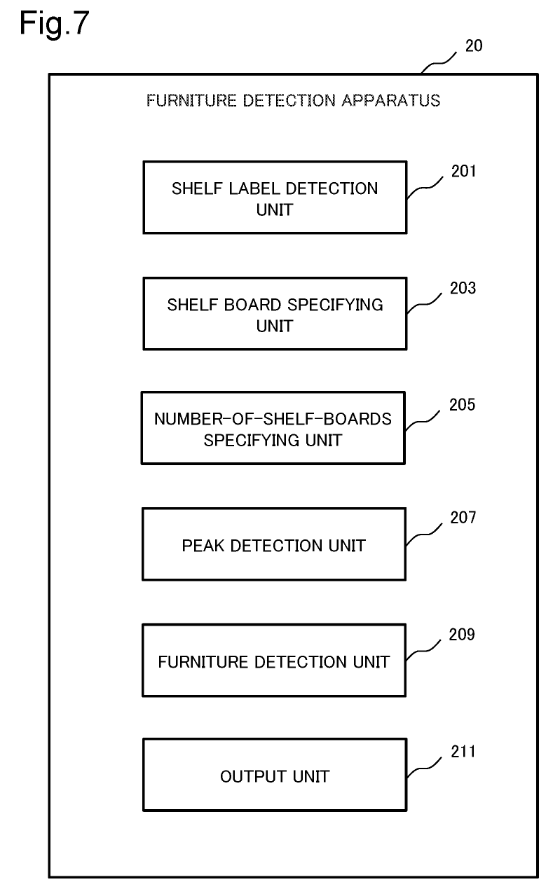

FIG. 7 is a block diagram illustrating a configuration example of a furniture detection apparatus 20. The furniture detection apparatus 20 includes a shelf label detection unit 201, a shelf board specifying unit 203, a number-of-shelf-boards specifying unit 205, a peak detection unit 207, a furniture detection unit 209, and an output unit 211. The furniture detection apparatus 20 further includes the shelf label detection unit 201, the shelf board specifying unit 203, and the output unit 211 in addition to the furniture detection apparatus 10 illustrated in FIG. 1. The number-of-shelf-boards specifying unit 205 may include the number-of-shelf-boards specifying unit 105 illustrated in FIG. 1 as a basic function. The peak detection unit 207 may include the peak detection unit 107 illustrated in FIG. 1 as a basic function. The furniture detection unit 209 may include the furniture detection unit 109 illustrated in FIG. 1 as a basic function.

The shelf label detection unit 201 detects a plurality of shelf labels from an image captured so that a plurality of pieces of furniture is included. For example, a method of detecting a shelf label may be based on a shape of the shelf label, and is not particularly limited. For example, as the method of detecting a shelf label, it is only required to use an existing technology, and a detailed description thereof will be omitted.

The shelf board specifying unit 203 specifies position information regarding a plurality of shelf boards in the image, based on position information regarding the detected plurality of shelf labels. The shelf label to be detected may be either a paper shelf label or an electronic shelf label.

Specifically, for example, the shelf board specifying unit 203 selects a combination of shelf labels closest to each other, in the height direction (y-axis direction) of the plurality of pieces of furniture, from a set of the detected plurality of shelf labels. Then, the shelf board specifying unit 203 derives a straight line passing through the combination of shelf labels.

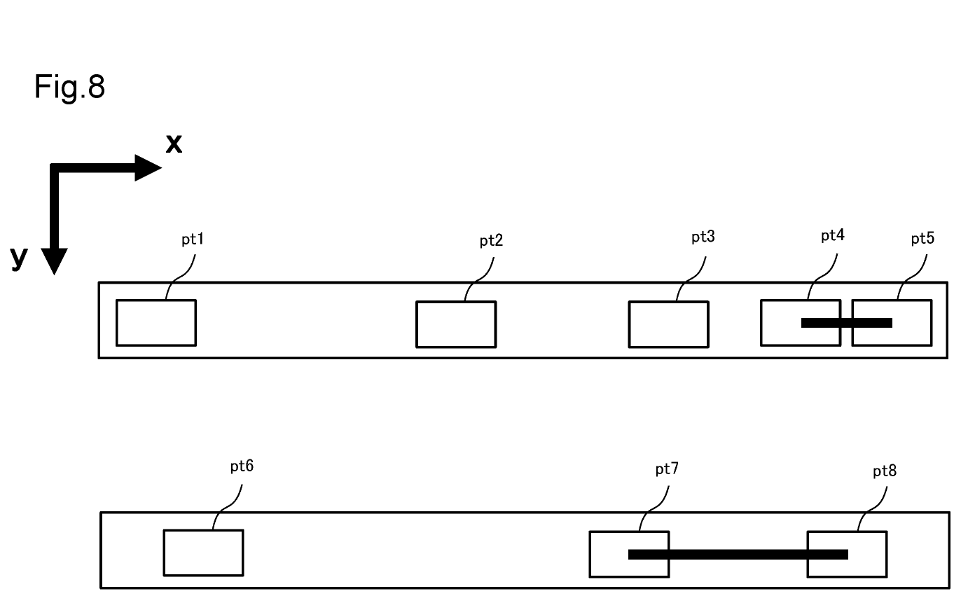

FIG. 8 is an explanatory diagram illustrating a selection example of the combination of shelf labels closest to each other, in the height direction, and a straight line example. In FIG. 8, shelf labels pt1 to pt8 are illustrated. In FIG. 8, there are the shelf labels pt1 to pt5 having substantially the same height in the height direction (y-axis direction). In this case, the shelf label pt4 and the shelf label pt5 are a combination having the shortest distance. The shelf board specifying unit 203 therefore derives a straight line passing through the shelf label pt4 and the shelf label pt5. In FIG. 8, there are the shelf labels pt6 to pt8 having substantially the same height in the height direction (y-axis direction). In this case, the shelf label pt7 and the shelf label pt8 are a combination having the shortest distance. The shelf board specifying unit 203 therefore derives a straight line passing through the shelf label pt7 and the shelf label pt8.

Next, the shelf board specifying unit 203 specifies a shelf label subset whose distance to the derived straight line is equal to or less than a threshold in the set of the plurality of shelf labels. The threshold is used, for example, to detect a shelf label that is considered to be installed on the same shelf board. For this reason, the threshold may be set by use of the sizes of the pieces of furniture introduced. Here, the shelf board specifying unit 203 specifies a shelf label subset whose distance to the straight line is equal to or less than the threshold even for shelf labels having different heights. In FIG. 8, for example, the shelf board specifying unit 203 specifies a shelf label subset whose distance to the straight line passing through the shelf label pt4 and the shelf label pt5 is equal to or less than the threshold. In FIG. 8, for example, the shelf board specifying unit 203 specifies a shelf label subset whose distance to the straight line passing through the shelf label pt7 and the shelf label pt8 is equal to or less than the threshold. Then, the shelf board specifying unit 203 further derives a straight line from the shelf label subset. For example, the shelf board specifying unit 203 derives a straight line from the shelf label subset by using a Random Sample Consensus (RANSAC) algorithm. The RANSAC algorithm is an iterative algorithm for estimating parameters of a model including an outlier from a data set. That is, when estimating a straight line of a shelf board from the position information regarding the shelf labels, the shelf board specifying unit 203 detects an optimum straight line while excluding the outlier of an erroneously detected shelf label or the like. With respect to the derived straight line, the shelf board specifying unit 203 estimates, as a shelf board, a region sandwiched between a maximum value and a minimum value of positions in the lateral direction in the shelf label subset. The maximum value is the above-described upper limit value, and the minimum value is the above-described lower limit value. The sandwiched region includes the maximum value but does not include the minimum value, similarly to the shelf board region described in the first example embodiment. As a result, the shelf board specifying unit 203 can specify the position information regarding the shelf boards.

Then, the number-of-shelf-boards specifying unit 205 specifies, based on the position information regarding the plurality of shelf boards in the image captured so that the plurality of pieces of furniture is included, transition of the number of shelf boards in the lateral direction of the plurality of pieces of furniture included in the image, as described in the first example embodiment. The number-of-shelf-boards specifying unit 205, the peak detection unit 207, and the furniture detection unit 209 may be similar to those in the first example embodiment, and thus detailed description thereof will be omitted.

The output unit 211 may output a detection result of the pieces of furniture. Output methods include display, voice output, and storage to a storage unit, and are not particularly limited. Output destinations include a terminal and the like, and are not particularly limited. For example, the terminal may be a device of a person in charge who performs inventory management, and is not particularly limited. The type of the terminal may be a Personal Computer (PC), a smartphone, a tablet device, or the like. The output unit 211 may output the detection result of the pieces of furniture in association with the image captured so that the plurality of pieces of furniture is included. Taking the display as an example, the output unit 211 may superimpose and display the detection result of the pieces of furniture on the image captured so that the plurality of pieces of furniture is included. More specifically, for example, the output unit 211 may superimpose and display, on the image, frames at locations detected as the pieces of furniture.

The output unit 211 may output, for example, a specifying result of a boundary. Similarly to the detection result of the pieces of furniture, the output method and the output destination are not particularly limited. For example, the output unit 211 may output the specifying result of the boundary in association with the image captured so that the plurality of pieces of furniture is included. Taking the display as an example, the output unit 211 may superimpose and display the specifying result of the boundary on the image captured so that the plurality of pieces of furniture is included.

### Flowchart

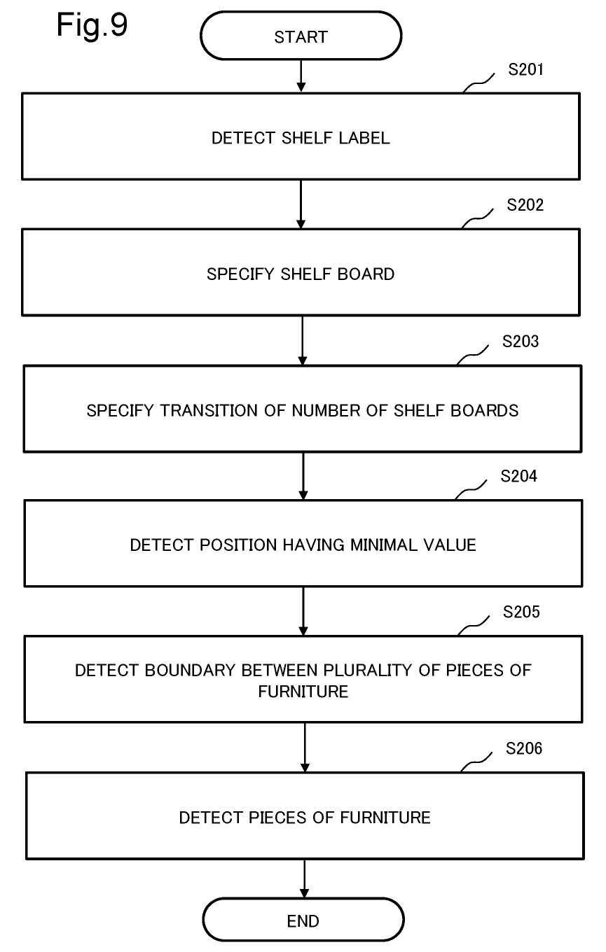

FIG. 9 is a flowchart illustrating an operation example of the furniture detection apparatus 20. The shelf label detection unit 201 detects shelf labels from an image captured so that a plurality of pieces of furniture is included (step S201).

Then, the shelf board specifying unit 203 specifies the position information regarding the plurality of shelf boards in the image, based on the position information regarding the plurality of shelf labels (step S202).

Next, the number-of-shelf-boards specifying unit 205 specifies the transition of the number of shelf boards in the lateral direction of the plurality of pieces of furniture included in the image, based on the position information regarding the plurality of shelf boards in the image captured so that the plurality of pieces of furniture is included (step S203). Next, the peak detection unit 207 detects a position in the lateral direction, the position having a minimal value in the transition of the number of shelf boards in the lateral direction (step S204). The furniture detection unit 209 detects a boundary between the plurality of pieces of furniture from the image, based on the detected position in the lateral direction (step S205). Then, the furniture detection unit 209 detects regions sandwiched between the boundary and ends of the plurality of pieces of furniture as the pieces of furniture (step S206), and the furniture detection apparatus 20 ends a series of processes illustrated in FIG. 9.

As described above, in the second example embodiment, the furniture detection apparatus 20 detects a plurality of shelf labels from an image. Then, the furniture detection apparatus 20 specifies position information regarding a plurality of shelf boards in the image, based on position information regarding the detected plurality of shelf labels. Specifically, the furniture detection apparatus 20 selects a combination of shelf labels closest to each other, in the height direction of the plurality of pieces of furniture, from a set of the detected plurality of shelf labels, and derives a straight line passing through the selected combination of shelf labels. With respect to a straight line derived from a subset whose distance to the derived straight line is equal to or less than the threshold in the set of the plurality of shelf labels, the furniture detection apparatus 20 estimates, as a shelf board, a region sandwiched between a maximum value and a minimum value of positions in the lateral direction in the shelf label subset. As a result, even if the position information regarding the shelf boards is not input, it is possible to indirectly estimate the position information regarding the shelf boards by using the positions of the shelf labels.

Thus, the description of each example embodiment ends. The example embodiments are not limited to the examples described above, and various modifications can be made. The first example embodiment and the second example embodiment may be appropriately combined with each other. There is no particular limitation on how the first example embodiment and the second example embodiment are combined with each other.

### Modification

The relationship of lower limit value < shelf board region ≤ upper limit value is used, but the relationship of lower limit value ≤ shelf board region < upper limit value may be used. In this case, the reference value is an upper limit value in the lateral direction (x-axis direction) of a certain shelf board. In particular, in a case where the position information regarding the shelf boards is estimated based on the position information regarding the shelf labels, it is predicted that an end of a piece of furniture, that is, a boundary of the piece of furniture is present in a positive direction in the lateral direction (x-axis direction) from the shelf label on the shelf board including the reference value. The furniture detection units 109 and 209 specify a boundary between a plurality of pieces of furniture, based on a detected position in the lateral direction, and detect each piece of furniture from an image, based on the specified boundary. As processing of specifying the boundary more specifically, the furniture detection units 109 and 209 specify a boundary including a position near the detected position as a boundary between the plurality of pieces of furniture. In more detailed description, the furniture detection units 109 and 209 specify lower limit values present in a positive direction in the x-axis direction from the reference value in a set of lower limit values in the lateral direction of the shelf boards. The furniture detection units 109 and 209 specify a minimum value among the specified lower limit values. In a case where a plurality of pieces of furniture is arranged, the minimum value is an x-coordinate value of a shelf label installed at an end of a shelf board of a piece of furniture adjacent to a piece of furniture having the reference value. As described above, the furniture detection units 109 and 209 specify a position between the minimum value and the reference value as an x-coordinate value of the boundary between the plurality of pieces of furniture. The position between the minimum value and the reference value may be, for example, a position that is an average value of the minimum value and the reference value.

For example, each example embodiment and modification may be appropriately combined with each other. The configurations of the furniture detection apparatuses 10 and 20 are not particularly limited. For example, the functional units of each of the furniture detection apparatuses 10 and 20 may be implemented by one device. Alternatively, for example, the functional units or databases of each of the furniture detection apparatuses 10 and 20 may be implemented by different devices from each other and may be configured as a system. For example, the functional units of each of the furniture detection apparatuses 10 and 20 may be constituted by a plurality of devices. For example, a system may be implemented that includes a database server including each database and a device including each functional unit. A system may be implemented that includes a device including a part of the functional units of each of the furniture detection apparatuses 10 and 20 and a device including another part of the functional units of each of the furniture detection apparatuses 10 and 20. The number of devices is not particularly limited.

The various sorts of information are examples and may further include other information or may not include some information.

Processing of generating information or the like to be displayed on the terminal may be performed by the output unit. This processing may be performed by the terminal. That is, the terminal may generate screen information to be displayed on the terminal, based on data received from the furniture detection apparatus 20, and display a screen, based on the screen information. User interfaces in the example embodiments are examples, and various changes can be made.

### Hardware Configuration Example of Computer

Next, a description will be given of a hardware configuration example in a case where each of apparatuses such as the furniture detection apparatuses 10 and 20 and the terminal is implemented by a computer.

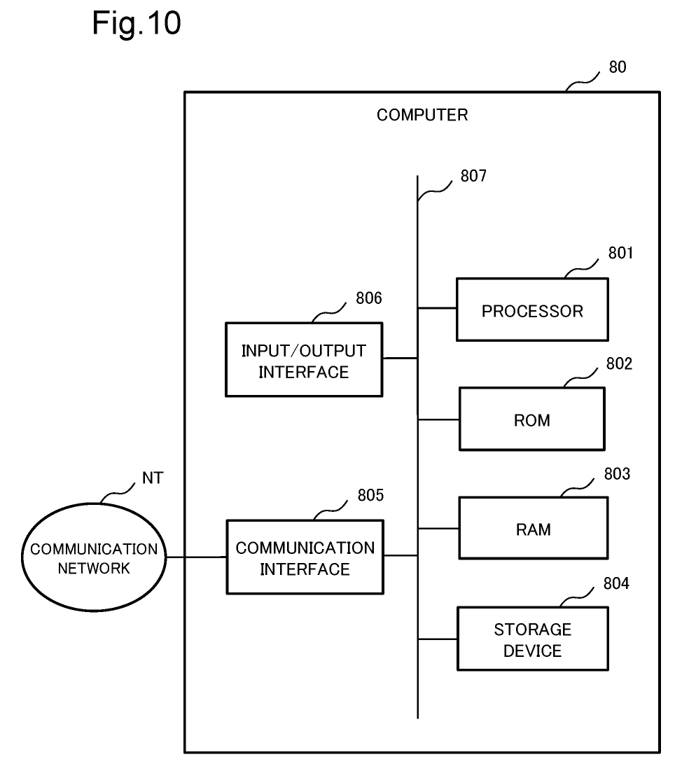

FIG. 10 is an explanatory diagram illustrating a hardware configuration example of a computer. For example, it is also possible to implement a part or the whole of each apparatus by using any combination of a computer 80 as illustrated in FIG. 10 and programs.

The computer 80 includes, for example, a processor 801, a Read Only Memory (ROM) 802, a Random Access Memory (RAM) 803, and a storage device 804. The computer 80 also includes a communication interface 805 and an input/output interface 806. The constituents are connected to each other via a bus 807, for example. The number of constituents is not particularly limited, and one or more constituents are provided.

The processor 801 controls the entire computer 80. The processor 801 is not particularly limited, and it is possible to use, for example, a Central Processing Unit (CPU), a Digital Signal Processor (DSP), a Graphics Processing Unit (GPU), a Physics Processing Unit (PPU), a Tensor Processing Unit (TPU), a quantum processor, or a combination thereof.

The computer 80 includes the ROM 802, the RAM 803, the storage device 804, and the like. Examples of the storage device 804 include a semiconductor memory such as a flash memory, a Hard Disk Drive (HDD), and a Solid State Drive (SSD). For example, the storage device 804 stores an Operating System (OS) program, an application program, a program according to each example embodiment, and the like. Alternatively, the ROM 802 stores an application program, a program according to the example embodiments, and the like. The RAM 803 is used as a work area for the processor 801.

The processor 801 loads a program stored in the storage device 804, the ROM 802, or the like. The processor 801 executes each process coded in the program. The processor 801 may download various sorts of programs via a communication network NT. The processor 801 functions as a part or the whole of the computer 80. The processor 801 may execute the processes or instructions in the flowcharts illustrated in the drawings, based on the programs.

The communication interface 805 is connected to the communication network NT such as a Local Area Network (LAN) or a Wide Area Network (WAN) through a wireless or wired communication line. The communication network NT may be constituted by a plurality of communication networks NT. As a result, the computer 80 is connected to an external device or an external computer 80 via the communication network NT. The communication interface 805 takes control of an interface between the communication network NT and the inside of the computer 80. The communication interface 805 controls input and output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is an example. The computer 80 may include some components illustrated in FIG. 10. The computer 80 may include a component other than those illustrated in FIG. 10. For example, the computer 80 may include a drive device. The processor 801 may read a program or data stored in a recording medium attached to the drive device or the like into the RAM 803. Examples of the non-transitory tangible recording medium include an optical disc, a flexible disk, a magneto-optical disc, and a Universal Serial Bus (USB) memory.

The computer 80 may include various sorts of sensors (not illustrated). The type of the sensor is not particularly limited. The computer 80 may include an imaging device capable of capturing images and videos.

Thus, the description of the hardware configuration of each apparatus ends. The method for implementing each apparatus has various modifications. For example, each apparatus may be implemented by any combination of computers and programs different for each component. A plurality of components included in each apparatus may be implemented by any combination of one computer and programs.

Some or all of the components of the apparatuses may be implemented by an application specific circuit. Some or all of the components of the apparatuses may be implemented by a general-purpose circuit such as a Field Programmable Gate Array (FPGA). Some or all of the components of the apparatuses may be implemented by a combination of an application specific circuit, a general-purpose circuit, and the like. These circuits each may be a single integrated circuit. Alternatively, these circuits each may be divided into a plurality of integrated circuits. The plurality of integrated circuits may be configured by being connected to each other via a bus or the like.

In a case where some or all of the components of the apparatuses are implemented by a plurality of computers, circuits, and the like, the plurality of computers, circuits, and the like may be disposed in a centralized manner or in a distributed manner.

The furniture detection method described in each example embodiment may be executed and implemented by a computer of the furniture detection apparatus 10 or 20, or the like.

Each program described in each example embodiment is recorded in a computer-readable recording medium such as an HDD, an SSD, a flexible disk, an optical disc, a magneto-optical disc, or a USB memory. Each program is read from the recording medium and executed by the computer. Each program may be distributed via the communication network NT.

The function of each component of the furniture detection apparatuses 10 and 20 described above may be implemented by dedicated hardware such as a computer. Alternatively, each component may be implemented by software. Alternatively, each component may be implemented by a combination of hardware and software.

While the present disclosure has been described with reference to the example embodiments, the present disclosure is not limited to the example embodiments described above. The configurations and details of the present disclosure may include example embodiments to which various changes that can be grasped by those skilled in the art within the scope of the present disclosure are applied. The present disclosure may include example embodiments in which the matters described in the present specification are appropriately combined or replaced, as necessary. For example, the matters described with a specific example embodiment can be applied to other example embodiments as long as no contradiction occurs. For example, although a plurality of operations is described in order in the form of a flowchart, the described order does not limit the order in which the plurality of operations is executed. Thus, when each example embodiment is carried out, the order of the plurality of operations can be changed within a range that does not interfere with the content.

Some or all of the example embodiments described above may also be described as Supplementary Notes below. However, some or all of the example embodiments described above are not limited to the following.

### Supplementary Note 1

A furniture detection apparatus including a number-of-shelf-boards specifying unit for specifying, based on position information regarding a plurality of shelf boards in an image captured in such a way that a plurality of pieces of furniture is included, transition of the number of shelf boards in a lateral direction of the plurality of pieces of furniture included in the image, a peak detection unit for detecting a position in the lateral direction, the position having a minimal value in the transition of the number of shelf boards in the lateral direction, and a furniture detection unit for detecting the pieces of furniture from the image, based on the position in the lateral direction detected.

### Supplementary Note 2

The furniture detection apparatus according to Supplementary Note 1, in which the furniture detection unit specifies a boundary between the plurality of pieces of furniture, based on the position in the lateral direction detected, and detects the pieces of furniture from the image, based on the boundary specified.

### Supplementary Note 3

The furniture detection apparatus according to Supplementary Note 2, in which the furniture detection unit specifies a boundary including a position near the position detected, as the boundary between the plurality of pieces of furniture.

### Supplementary Note 4

The furniture detection apparatus according to any of Supplementary notes 1 to 3, in which the number-of-shelf-boards specifying unit specifies, as a shelf board region, a range of a value equal to or less than an upper limit value in the lateral direction and larger than a lower limit value in the lateral direction of each of the plurality of shelf boards, and specifies the transition of the number of shelf boards, based on the shelf board region of each of the plurality of shelf boards.

### Supplementary Note 5

The furniture detection apparatus according to Supplementary Note 4, in which in a case where a size of the shelf board region in the lateral direction is outside a predetermined range, the number-of-shelf-boards specifying unit excludes the shelf board region of which the size is outside the predetermined range in counting of the number of shelf boards.

### Supplementary Note 6

The furniture detection apparatus according to any of Supplementary notes 1 to 5, in which the number-of-shelf-boards specifying unit specifies the transition of the number of shelf boards by specifying the number of shelf boards in each of the upper limit value and the lower limit value in the lateral direction of each of the plurality of shelf boards indicated by the position information regarding the plurality of shelf boards.

### Supplementary Note 7

The furniture detection apparatus according to any of Supplementary notes 1 to 6, further including a shelf board specifying unit for specifying the position information regarding the plurality of shelf boards in the image, based on position information regarding a plurality of shelf labels.

### Supplementary Note 8

The furniture detection apparatus according to Supplementary Note 7, in which the shelf board specifying unit selects a combination of shelf labels closest to each other, in a height direction of the plurality of pieces of furniture, from a set of the plurality of shelf labels detected, and derives a straight line passing through the combination of the shelf labels selected, and for a straight line derived from a shelf label subset whose distance to the straight line derived is equal to or less than a threshold in the set of the plurality of shelf labels, estimates, as a shelf board, a region sandwiched between a maximum value and a minimum value of positions in the lateral direction in the shelf label subset.

### Supplementary Note 9

The furniture detection apparatus according to Supplementary Note 7 or 8, further including a shelf label detection unit for detecting the plurality of shelf labels from the image.

### Supplementary Note 10

The furniture detection apparatus according to any of Supplementary Notes 1 to 9, including an output unit for outputting a detection result of the pieces of furniture.

### Supplementary Note 11

A furniture detection method in which a computer executes processing of specifying, based on position information regarding a plurality of shelf boards in an image captured in such a way that a plurality of pieces of furniture is included, transition of the number of shelf boards in a lateral direction of the plurality of pieces of furniture included in the image, detecting a position in the lateral direction, the position having a minimal value in the transition of the number of shelf boards in the lateral direction, and detecting the pieces of furniture from the image, based on the position in the lateral direction detected.

### Supplementary Note 12

A program for causing at least one computer to execute processing of specifying, based on position information regarding a plurality of shelf boards in an image captured in such a way that a plurality of pieces of furniture is included, transition of the number of shelf boards in a lateral direction of the plurality of pieces of furniture included in the image, detecting a position in the lateral direction, the position having a minimal value in the transition of the number of shelf boards in the lateral direction, and detecting the pieces of furniture from the image, based on the position in the lateral direction detected.

### Supplementary Note 13

A non-transitory recording medium readable by at least one computer, the non-transitory recording medium recording a program for causing the at least one computer to execute processing of specifying, based on position information regarding a plurality of shelf boards in an image captured in such a way that a plurality of pieces of furniture is included, transition of the number of shelf boards in a lateral direction of the plurality of pieces of furniture included in the image, detecting a position in the lateral direction, the position having a minimal value in the transition of the number of shelf boards in the lateral direction, and detecting the pieces of furniture from the image, based on the position in the lateral direction detected.

Some or all of the configurations described in Supplementary Notes 2 to 10 subordinate to Supplementary Note 1 described above can also be subordinate to Supplementary Notes 11, 12, and 13 with a subordinate relationship similar to that of Supplementary Notes 2 to 10. Furthermore, some or all of the configurations described as Supplementary Notes can be similarly subordinate to not only Supplementary Notes 1, 11, 12, and 13, but also various pieces of hardware and software, and a variety of recording means for recording software, or a system without departing from the above-described example embodiments.

1. A furniture detection apparatus comprising:
one or more memories storing instructions; and
one or more processors configured to execute the instructions to:
specify, based on position information regarding a plurality of shelf boards in an image captured in such a way that a plurality of pieces of furniture is included, transition of a number of shelf boards in a lateral direction of the plurality of pieces of furniture included in the image;
detect a position in the lateral direction, the position having a minimal value in the transition of the number of shelf boards in the lateral direction; and
detect the pieces of furniture from the image, based on the position in the lateral direction detected.

2. The furniture detection apparatus according to claim 1, wherein the one or more processors are further configured to execute the instructions to:
specify a boundary between the plurality of pieces of furniture, based on the position in the lateral direction detected, and detect the pieces of furniture from the image, based on the boundary specified.

3. The furniture detection apparatus according to claim 2, wherein the one or more processors are further configured to execute the instructions to:
specify a boundary including a position near the position detected, as the boundary between the plurality of pieces of furniture.

4. The furniture detection apparatus according to claim 1, wherein the one or more processors are further configured to execute the instructions to:
specify, as a shelf board region, a range of a value equal to or less than an upper limit value in the lateral direction and larger than a lower limit value in the lateral direction of each of the plurality of shelf boards, and specify the transition of the number of shelf boards, based on the shelf board region of each of the plurality of shelf boards.

5. The furniture detection apparatus according to claim 4, wherein the one or more processors are further configured to execute the instructions to:
in a case where a size of the shelf board region in the lateral direction is outside a predetermined range, exclude the shelf board region of which the size is outside the predetermined range in counting of the number of shelf boards.

6. The furniture detection apparatus according to claim 1, wherein the one or more processors are further configured to execute the instructions to:
specify the transition of the number of shelf boards by specifying the number of shelf boards in each of the upper limit value and the lower limit value in the lateral direction of each of the plurality of shelf boards indicated by the position information regarding the plurality of shelf boards.

7. The furniture detection apparatus according to claim 1, wherein the one or more processors are further configured to execute the instructions to:
specify the position information regarding the plurality of shelf boards in the image, based on position information regarding a plurality of shelf labels.

8. The furniture detection apparatus according to claim 7, wherein the one or more processors are further configured to execute the instructions to:
select a combination of shelf labels closest to each other, in a height direction of the plurality of pieces of furniture, from a set of the plurality of shelf labels detected, and derive a straight line passing through the combination of the shelf labels selected; and
for a straight line derived from a shelf label subset whose distance to the straight line derived is equal to or less than a threshold in the set of the plurality of shelf labels, estimate, as a shelf board, a region sandwiched between a maximum value and a minimum value of positions in the lateral direction in the shelf label subset.

9. A furniture detection method wherein
a computer executes processing of:
specifying, based on position information regarding a plurality of shelf boards in an image captured in such a way that a plurality of pieces of furniture is included, transition of a number of shelf boards in a lateral direction of the plurality of pieces of furniture included in the image;
detecting a position in the lateral direction, the position having a minimal value in the transition of the number of shelf boards in the lateral direction; and
detecting the pieces of furniture from the image, based on the position in the lateral direction detected.

10. A non-transitory recording medium readable by a computer, the non-transitory recording medium recording a program for causing
a computer to execute processing of:
specifying, based on position information regarding a plurality of shelf boards in an image captured in such a way that a plurality of pieces of furniture is included, transition of a number of shelf boards in a lateral direction of the plurality of pieces of furniture included in the image;
detecting a position in the lateral direction, the position having a minimal value in the transition of the number of shelf boards in the lateral direction; and
detecting the pieces of furniture from the image, based on the position in the lateral direction detected.
